(19) United States
(12) Patent Application Publication
(10) Pub. No.: US 2018/0048100 A1
(43) Pub. Date: Feb. 15, 2018

(54) TEST RF CONNECTOR

(71) Applicant: Microsoft Technology Licensing, LLC, Redmond, WA (US)

(72) Inventor: Pasi Moilanen, Jyvaskyla (FI)

(21) Appl. No.: 15/232,702

(22) Filed: Aug. 9, 2016

(51) Int. Cl. H01R 24/50; H01R 43/20; H01R 43/26; H01R 12/71

(52) U.S. Cl. CPC H01R 24/50; H01R 12/716; H01R 43/205; H01R 43/26; H01R 2103/00

(57) ABSTRACT

In an embodiment, an RF device comprises: a test RF connector, a device housing, the device housing comprising at least one conductive portion, and a grounding connector configured to electrically connect the at least one conductive portion to a ground of the test RF connector.

### BACKGROUND

Electronic and/or computing devices may have antennas. Some devices, like smartphones may comprise more than one antenna and multiple associated radio frequency (RF) components, for example, antenna feeds. Before assembly of the device, these RF components may need to be tested.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

An RF device is described. In an embodiment, an RF device comprises: a test RF connector, a device housing, the device housing comprising at least one conductive portion, and a grounding connector configured to electrically connect the at least one conductive portion to a ground of the test RF connector.

In other embodiments, a test RF connector and a method are discussed.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a schematic representation of a RF device comprising a device cover, according to an embodiment;

FIG. 2 illustrates a sectional view of a RF device, showing a printed circuit board (PCB) with test RF connectors of the device, according to an embodiment;

FIG. 3 illustrates a perspective view of a test RF connector according to an embodiment;

FIG. 4 illustrates a top view of a test RF connector according to an embodiment;

FIG. 5 illustrates a sectional side view of a portion of a RF device according to an embodiment, showing a test RF connector, and portions of a RF device PCB and a RF device cover;

FIG. 6 illustrates a side view of a configuration of a test RF connector in a device comprising a spring element attached to a RF device cover, according to an embodiment;

FIG. 7 illustrates a side view of a test RF connector comprising an outer conductor with a spring, according to an embodiment;

FIG. 8 illustrates a side view of a test RF connector comprising an electrical component configured on top of a spring element, according to an embodiment;

FIG. 9A illustrates a perspective view of a test RF connector comprising a base, according to an embodiment;

FIG. 9B illustrates a perspective view of a mating portion of a test RF connector, according to an embodiment;

FIG. 10 illustrates a sectional side view of a test RF connector comprising two complementary halves, according to an embodiment;

FIG. 11 illustrates a perspective view of a test RF connector comprising a lamellar spring element, according to an embodiment;

FIG. 12 illustrates a side view of a test RF connector comprising a lamellar spring element; and

FIG. 13 illustrates a schematic flow chart of a method of assembly in accordance with an embodiment.

Like references are used to designate like parts in the accompanying drawings. It should be noted that the appended drawings are illustrative representations and are not the only forms and/or structures in which the present embodiments may be accomplished. Further, the drawings may not be to scale.

### DETAILED DESCRIPTION

The detailed description provided below in connection with the appended drawings is intended as a description of the embodiments and is not intended to represent the only forms in which the embodiment may be constructed or utilized. However, the same or equivalent functions and structures may be accomplished by different embodiments.

Although the embodiments may be described and illustrated herein as being implemented in a smartphone, this is only an example of a radio frequency (RF) device and not a limitation. As those skilled in the art will appreciate, the present embodiments are suitable for application in a variety of different types of RF devices comprising RF components, for example mobile phones, tablets, phablets, portable game consoles, wearable devices, media players, wireless headphones, smart watches etc. Devices capable of wireless communication invariably comprise RF components and may be referred to as RF devices. RF components may include any components needed and/or used in a wireless communication set up using radio and/or microwave frequency electromagnetic waves, for example, receivers, transmitters, antenna feeds, feed lines, antennas, connectors connecting two RF components etc.

A conductive cover, a part thereof or a conductive portion of an RF device cover may be used as an antenna. Before assembly, RF components configured on a device printed circuit board (PCB) may need to be tested, for example to assure performance, measure radiation parameters, etc. Typically, test RF connectors are configured on the RF device PCB for such testing. After the RF device is assembled, these test RF connectors are used very infrequently, for example, if RF components on the device PCB need to be repaired or tested again.

Currently miniaturization of portable and wearable devices is the trend in RF devices. This requires squeezing more and more components onto smaller and smaller PCBs. In RF devices like smartphones, there may be multiple antenna feeds and antennas, requiring multiple test RF connectors, and thus occupying considerable space on a RF device PCB. Modern RF devices may comprise multiple metallic or conductive parts, for example, all metal device covers etc. which may need to be connected to ground plane of the device PCB. There may be multiple grounding connections needed, for example, to ground points on portions of RF device cover acting as antennas. A test RF connector, according to an embodiment, comprises a grounding connector which connects a point on a conductive device cover or a conductive portion of the device cover to an electrical ground on the device PCB. According to an embodiment, a test RF connector may act to ground a conductive cover after assembly. According to an embodiment, the space needed for grounding connectors may be reduced. According to an embodiment, number of dedicated grounding connectors may be reduced. According to an embodiment, test RF connectors may be utilized as grounding connectors after the RF device is assembled. According to an embodiment, a device PCB with space for more components may be implemented. According to an embodiment, more functionality may be provided in smaller PCBs with multiple RF components. In an embodiment, test RF connector comprises a removable grounding connector, so that an RF testing probe, used for testing, can be connected to the test RF connector when needed. In an embodiment, test RF connector comprises a fixed or integrated grounding connector configured in such a manner so as to not impede connection with a RF testing probe.

According to an embodiment, a test RF probe or an RF testing probe may be a component attachable to a test RF connector for testing purposes. It may, for example, comprise an RF connector complementary to a test RF connector and a coaxial cable configured to allow RF signals to be sent and received from the test RF connector. According to an embodiment, a grounding connecter may comprise a connector or component capable of electrically connecting a component or portion of an RF device, for example a device cover or a portion thereof, to an electrical ground of the device. Examples of a grounding connector include, but are not limited to, a conductive pin, a helical spring, a flat spring, a lamellar spring, a bendable piece of conductive material, a complementary connector not making connection with the signal conductor of the test RF connector, etc.

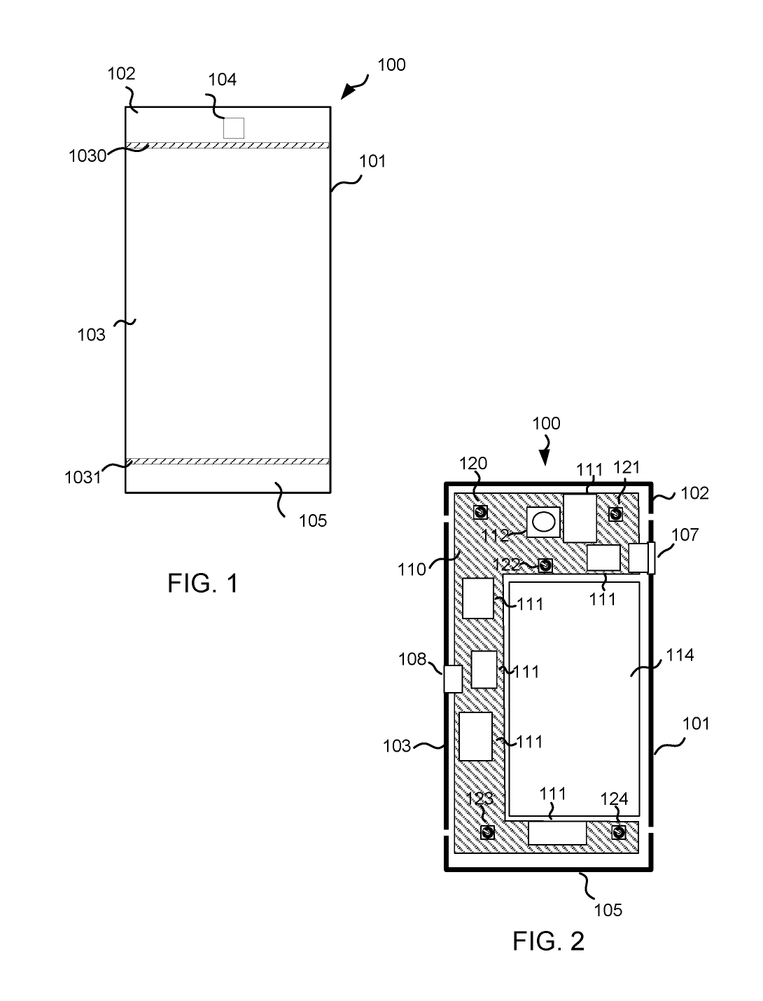

FIG. 1. illustrates an RF device 100 comprising a cover 101. The cover comprises portions 102, 103, 105. Further there may be windows or slots, for example, window 104 for some components, for example, a camera (not shown in FIG. 1) to have access to outside of the device cover 101. The device cover 101 may have slots 1030, 1031 for implementing antennas (not shown in FIG. 1). The antennas may be implemented on portions of device cover 101, for example, portion 102, or they may be implemented inside the device cover 101 and slots may be used for allowing, guiding, or forming desirable radiation patterns. According to an embodiment, RF device 100 may comprise both antennas implemented on the device cover 101 and antennas implemented inside the RF device 100. According to an embodiment, test RF connectors (not shown in FIG. 1) may comprise grounding connectors which connect portions of the device cover 101 to an electrical ground inside the RF device 100, for example on printed circuit board (PCB) of the RF device 100.

FIG. 2 illustrates a sectional view of a RF device 100, according to an embodiment. RF device 100 comprises a cover 101, a PCB 110 and battery 114. The device cover 101 may comprise portions 102, 103 and 105. Some or all of the portions 102, 103, 105 of device cover 101 may be conductive. Device cover 101 may comprise slots corresponding to components like power key 107, volume keys (not shown in FIG. 1) and connectivity port 108 etc. Various components 111, like a processor, system on chip, baseband processor, digital signal processors etc. may be configured on PCB 110. There may be other components like camera 112 configured on PCB 110. Further test RF connectors 120, 121, 122, 123, 124 may be configured on various locations on PCB 110. Various other components not shown in FIG. 2 may also be configured on PCB 110. According to an embodiment, test RF connectors 120, 121, 122, 123, 124 may occupy valuable space on PCB 110 which may otherwise be utilized to accommodate other components. According to an embodiment, each of the test RF connectors 120, 121, 122, 123, 124 comprises a grounding connector, configured to connect portions 102, 103, 105 of the device cover 101 to an electrical ground (not shown in FIG. 2) on PCB 110, reducing or eliminating the need for dedicated grounding connectors. According to an embodiment, test RF connectors 120 through 124 may be strategically placed at locations where electrical grounding of device cover or portions of device cover is needed, for example to ground an antenna radiator.

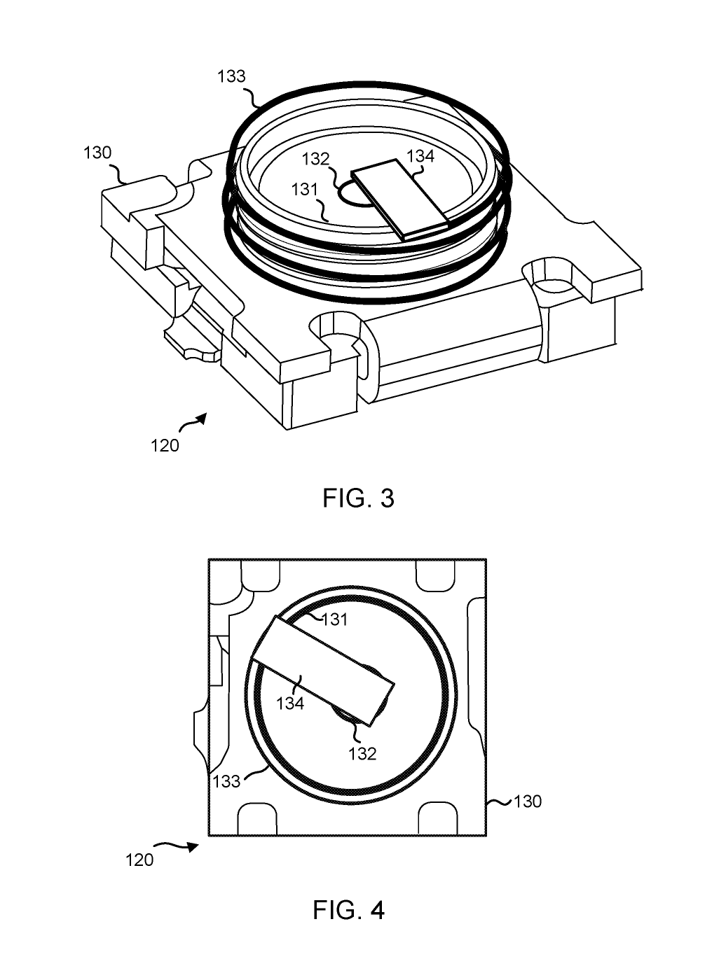

FIG. 3 illustrates a perspective view of a test RF connector 120 according to an embodiment. It comprises a base 130, an outer conductor 131, an inner conductor 132, a helical spring 133 and a conducting plate 134. The outer conductor 131 may be in the shape of a hollow cylinder, configured on the base 130. According to an embodiment, base 130 may be made of conductive material and the outer conductor 131 may be configured on it directly, with the hollow of outer conductor 131 configured to be on the top of a corresponding hole in the base 130. Inner conductor 132 may be configured in the middle of the hollow in the base 130 with the help of a non-conductive sabot like component carrying the inner conductor 132 in its center and fitting flush in the hollow of inner conductor 132. The base 130 and hence the outer conductor 131 configured on it, may be electrically connected to an electrical ground of a PCB. The inner conductor 132 may be connected to an antenna feed, for example via a co-axial cable or a feed line. According to an embodiment, there may be a switching mechanism to disconnect the antenna feed from the inner conductor. According to an embodiment, base 130 may be made of non-conductive material and the outer conductor 131 and inner conductor 132 may be electrically connectable to an electrical ground and an antenna feed respectively. The base may be attachable to a PCB. Spring 133 may be configured around the outer conductor 131 and/or resting on the base 130. Spring 133 may be in electrical contact with the base 130 if the base is conductive or with the outer conductor 131. The height of spring 133 in uncompressed state may be more than that outer conductor 131. A contact plate 134 may be configured on top of spring 133, such that the contact plate 134 is substantially parallel to base 130. The contact plate 134 may be of any shape suitable to make sufficient electrical contact with a device cover 102. According to an embodiment spring 133 may be removably configured. According to an embodiment, spring 133 may be irremovably configured and conductive plate 134 may be removably configured. According to an embodiment, inner conductor 132 may comprise a hollow cylinder with an opening to receive a corresponding mating pin. According to an embodiment, helical spring 133 may be configured inside the outer conductor 131, making electrical contact with its inner surface, but electrically isolated from the inner conductor 132. According to an embodiment, spring 133 and conducting plate 131 comprise a grounding connector, such that when the test RF connector 120 is configured on a PCB 110 conducting plate 134 it may be in a flush contact with a device cover 101 or a portion thereof, thereby electrically connecting the device cover 101, or a portion thereof, to the outer conductor 131 and/or base 130, which may be connected to an electrical ground on the PCB 110. In FIG. 3 PCB 110 and device cover 101 are not shown.

FIG. 4 illustrates a top view of a test RF connector 120 of FIG. 3, according to an embodiment. According to an embodiment, spring 133 and conductive plate 134 occupy lesser or the same area as occupied by the base 120, thereby saving space.

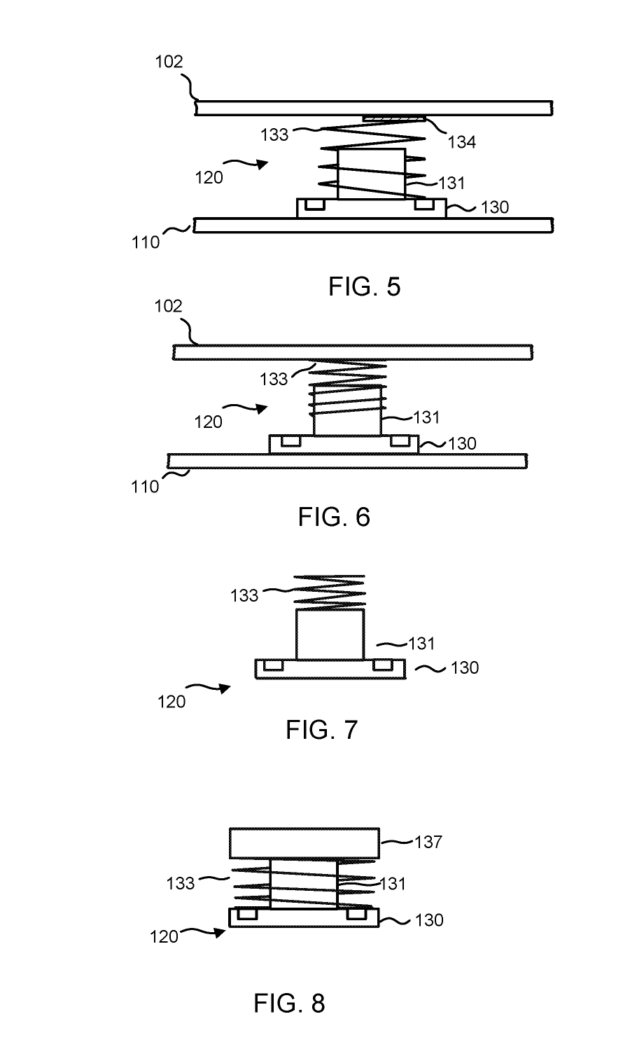

FIG. 5 illustrates a sectional side view of a portion of a device comprising a PCB 110, a test RF connector 120 configured on the PCB 110 and a conductive portion 102 of a device cover. Test RF connector 120 may comprise an outer conductor 131, an inner conductor 132 (not visible in FIG. 5), a base 130 which is configured on the PCB 110 and on which the outer conductor 131 and inner conductor 132 are configured, a helical spring 133 configured around the outer conductor 131 and a conductive plate 134 configured on top of the spring 133. The conductive plate 134 is in electrical contact with a conductive portion 102 of device cover. According to an embodiment, the base 130 may be conductive, comprising a hole in the middle to allow the inner conductor 132 to be configured therein, electrically isolated from conductive base 130. The outer conductor 131 is configured on the conductive base 130. According to an embodiment, the base 130 and outer conductor 131 may be a single component. The outer conductor 131 and hence the base 130 may be connected to an electrical ground on the PCB 110. The inner conductor 132 may be connected to an antenna feed on the PCB 110, for example via a feed line or a coaxial cable. According to an embodiment, the base 130 may be soldered to the PCB 110 and connected to an electrical ground. According to an embodiment, the base 130 may be non-conductive and may have space to receive the outer conductor 131 and the inner conductor 132. The outer conductor 131 may be connected to an electric ground on the PCB 110, for example through a via in base 130. Similarly, the inner conductor 132 may be connected through a via in base 130 to an antenna feed, for example, using a coaxial cable or a feed line. According to an embodiment, the conductive plate 134 on top of spring 133 may be of any shape suitable to make electrical contact with the cover portion 102. According to an embodiment, spring 133 and conductive plate 134 comprise a grounding connector grounding conductive portion 102 of the device cover.

FIG. 6 illustrates a side view of a section of a device according to an embodiment. The embodiment of FIG. 6 may be different from the embodiment illustrated in FIG. 5 in that the helical spring 133 may be configured to be soldered or welded to device cover portion 102 in such a way that when the device is assembled, the helical spring 133 either presses against the conductive base 130 or a surface of the outer conductor 131, thereby making an electrical connection which grounds the device cover portion 120. The helical spring 133 may enclose the outer conductor 131 in a concentric manner and press against the base 130, or it may envelope the outer conductor 131 or fit inside the outer conductor 131 in either case, the helical spring 133 making electrical contact with the outer conductor 131.

FIG. 7 illustrates a side view of a test RF connector 120, comprising a base 130, an outer cylindrical conductor 131, an inner conductor 132 (not visible in FIG. 7) and a helical spring 133. The base 130 may be conductive, having a hole corresponding to the hollow of the outer cylindrical conductor 131. The inner conductor 132 may be configured in the center of the hole, electrically isolated from the outer conductor 131 and the base 130. According to an embodiment, the base 130 and the outer conductor 131 may comprise a single component. The base 130 and hence the outer conductor 131 may be connectable to an electrical ground. The inner conductor 132 may be connectable to an antenna feed. According to an embodiment, the base 130 may comprise non-conductive material having concentric slits for the inner conductor 132 and outer conductor 131. The outer conductor being connectable to an electrical ground and inner conductor 132 connectable to a an antenna feed. The helical spring 133 may be configured on top of the outer conductor 131, such that the base of the spring 133 is flush with the top of the outer conductor 131. According to an embodiment, the helical spring 133 may be such that it compresses to allow a probe to be coupled with the test RF connector 120. According to an embodiment, helical spring 133 may comprise a grounding connector, such that when the test RF connector 120 is configured on a PCB 110 helical spring 133 it may be in flush contact with a portion 102 of device cover, thereby electrically connecting the portion 102 of device cover to the outer conductor 131 and/or base 130, which may be connected to an electrical ground on the PCB 110.

FIG. 8 illustrates a test RF connector 120 comprising a base 130, an outer connector 131, an inner connector (not visible in FIG. 8), a helical spring 133 and an electrical component 137. The test RF connector 120 of FIG. 8 may be similar to the test RF connector 120 of FIG. 3, 4 or 5, differing in that instead of a conductive part 134, an electrical component 137 may be configured on the spring 133. According to an embodiment, electrical component 137 may be a resistor, a capacitor, an inductor or a combination thereof. According to an embodiment, spring 133 and electrical component 137 comprise a grounding connector, such that when the test RF connector 120 is configured on a PCB 110 electrical component 137 it may be in flush contact with a device cover 101, or a portion thereof, thereby electrically connecting the device cover 101 or a portion thereof to the outer conductor 131 and/or base 130, which may be connected to an electrical ground on the PCB 110. In FIG. 8 PCB 110 and device cover 101 are not shown.

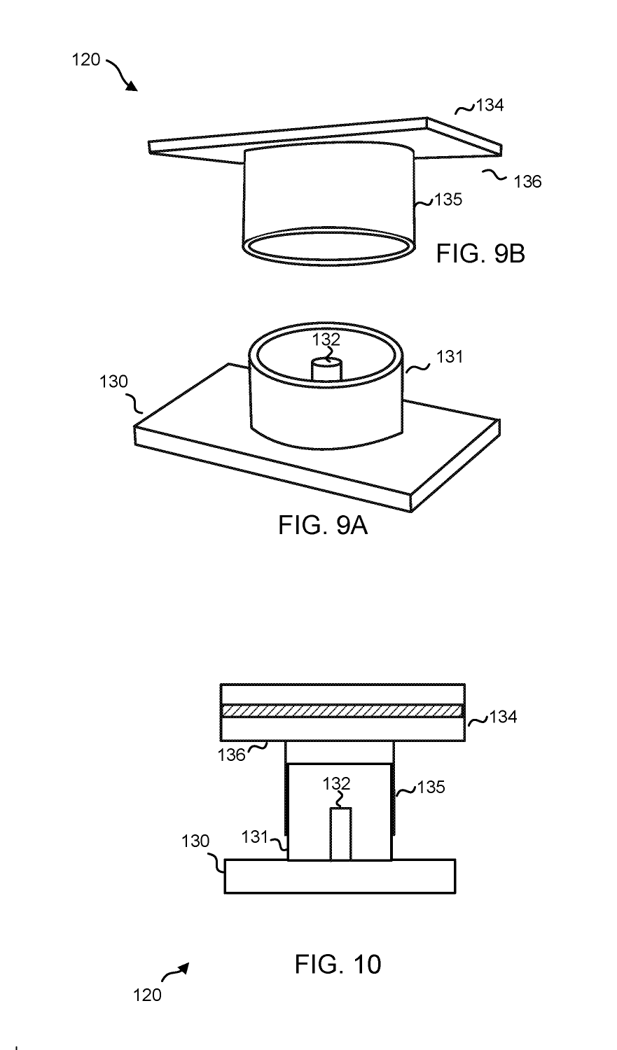

FIG. 9A illustrates a perspective view of a test RF connector according to an embodiment, comprising a base 130 an outer conductor 131, an inner conductor 132 configured within the outer conductor 131. FIG. 9B illustrates a perspective view of a mating portion 136 comprising a cylindrical part 135 and a flat part 134 configured on top of the base 130 and electrical contact with the cylindrical part 135. The cylindrical part 135 may be hollow with an inner diameter equal to or slightly greater than the outer diameter of the outer conductor 131, such that the two couple telescopically. According to an embodiment, the cylindrical part 135 of the mating portion 136 may have an outer diameter equal or slightly smaller than the inner diameter of outer conductor 131, so as to allow coupling telescopically. According to an embodiment, outer conductor 131 and the cylindrical part 135 may couple by way of a threading mechanism. According to an embodiment, the base 130 may be conductive having a hole corresponding to the outer cylindrical conductor 131. The inner conductor 132 may be configured in the center of the hole, electrically isolated from the outer conductor 131 and the base 130. According to an embodiment, the base 130 and the outer conductor 131 may comprise a single component. The base 130 and hence the outer conductor 131 may be connectable to an electrical ground. The inner conductor 132 may be connectable to an antenna feed. According to an embodiment, the base 130 may comprise non-conductive material having slots concentric slits for the inner conductor 132 and outer conductor 131. The outer conductor 131 being connectable to an electrical ground and inner conductor 132 connectable to a an antenna feed. According to an embodiment, the cylindrical part 135 of the mating portion may electrically connect the flat part 134 with the outer conductor 131 and/or the base 130 if it comprises conductive material. According to an embodiment, the flat part 134 may comprise an electrical component (not shown in FIG. 8) for example, a resistor, a capacitor, an inductor or a combination thereof. According to an embodiment, mating portion 136 may comprise a grounding connector, electrically grounding a device cover 101 or a portion thereof, by connecting it to an electrical ground on a PCB 110 on which test RF connector 120 is configured. In FIG. 9 PCB 110 and device cover 101 are not shown.

FIG. 10 illustrates a cross-sectional view of a test RF connector 120, according to an embodiment. It may be similar to the test RF connector 120 of FIG. 8 with the difference that flat part 134 of the mating portion 136 comprises a capacitor.

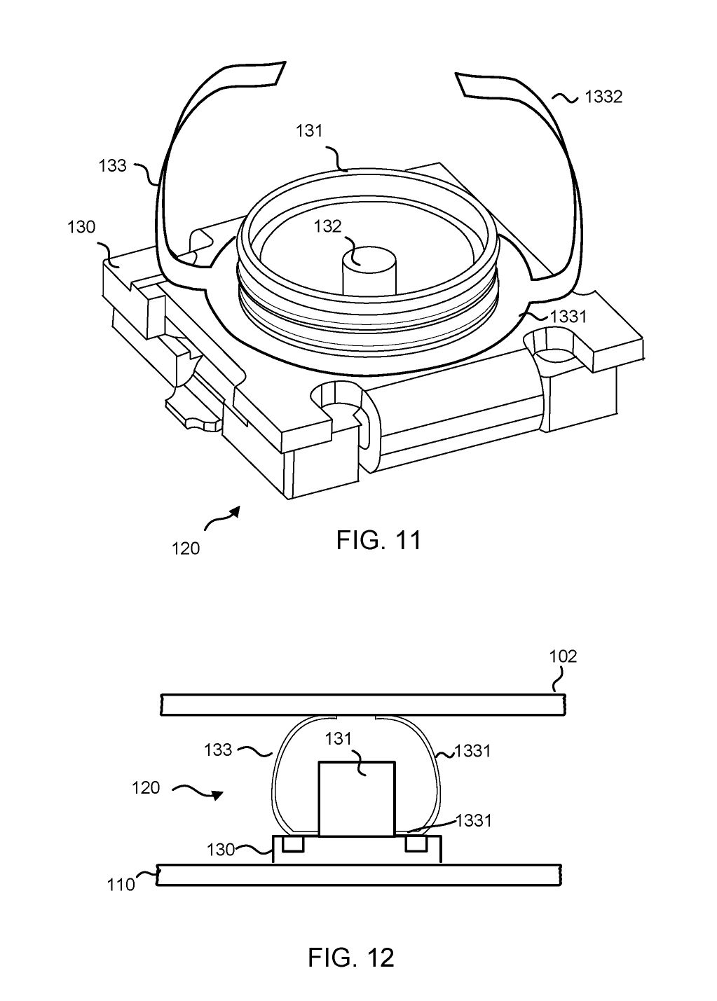

FIG. 11 illustrates a perspective view of a test RF connector 120, according to an embodiment. It comprises a base 130, an outer conductor 131, an inner conductor 132, and a lamellar spring 133. The outer conductor 131 is may be in the shape of a hollow cylinder, configured on the base 130. According to an embodiment, base 130 may be made of conductive material and the outer conductor 131 may be configured on it directly, with the hollow of outer conductor 131 configured to be on the top of a corresponding hollow in the base 130. Inner conductor 132 is configured in the middle of the hollow in the base 130 with the help of a non-conductive sabot carrying the inner conductor 132 in its center and fitting flush in the hollow of inner conductor 132. The base 130 and hence the outer conductor 131 configured on it, may be electrically connected to an electrical ground of a PCB. The inner conductor 132 may be connected to an antenna feed, for example via a co-axial cable or a feed line. According to an embodiment, there may be a switching mechanism to disconnect the antenna feed from the inner conductor. According to an embodiment, base 130 may be made of non-conductive material and the outer conductor 131 and inner conductor 132 may be electrically connectable to an electrical ground and an antenna feed respectively. The base may be configurable on a PCB. Spring 133 may comprise an annular part 1331 and two bending conductive strips 1332 extending from the annular part 1331. Annular part 1331 of the spring 133 may be configured around the outer conductor 131 and/or resting on the base 130. Spring 133 may be in electrical contact with the base 130 if the base is conductive or with the outer conductor 131. The height of spring 133 in uncompressed state is more than that outer conductor 131. The bending strips 1332 may be compressible so as to affect an electrical contact with a planar or a substantially planar object. According to an embodiment spring 133 may be removably configured. According to an embodiment, spring 133 may be irremovably configured such that when a probe is coupled with the RF test connector, the bending conductive strips 1332 give way. According to an embodiment, inner conductor 132 may comprise a hollow cylinder with an opening to receive a corresponding mating pin. According to an embodiment, spring 133 may be configured inside the outer conductor 131, making electrical contact with its inner surface, but electrically isolated from the inner conductor 132. According to an embodiment, the spring 133 may comprise one or more bending conductive strips 1332. According to an embodiment, mating portion 136 may comprise a grounding connector, electrically grounding a device cover 101 or a portion thereof, by connecting it to an electrical ground on a PCB 110 on which test RF connector 120 is configured. In FIG. 11 PCB 110 and device cover 101 are not shown.

FIG. 12 illustrates a side view of a section of a device showing test RF connector of FIG. 11 configured on a PCB 110, and electrically grounding a conductive portion 102 of the device cover via the bending strips 1331.

Although specific shapes of grounding connector, including shapes wherein grounding connector comprises a spring 133 may be described, other shapes which capable of connecting a conductive portion 102 of a device cover 101 with either the outer conductor 131 or base 130 or both base 130 and outer conductor 131 of a test RF connector, may be contemplated.

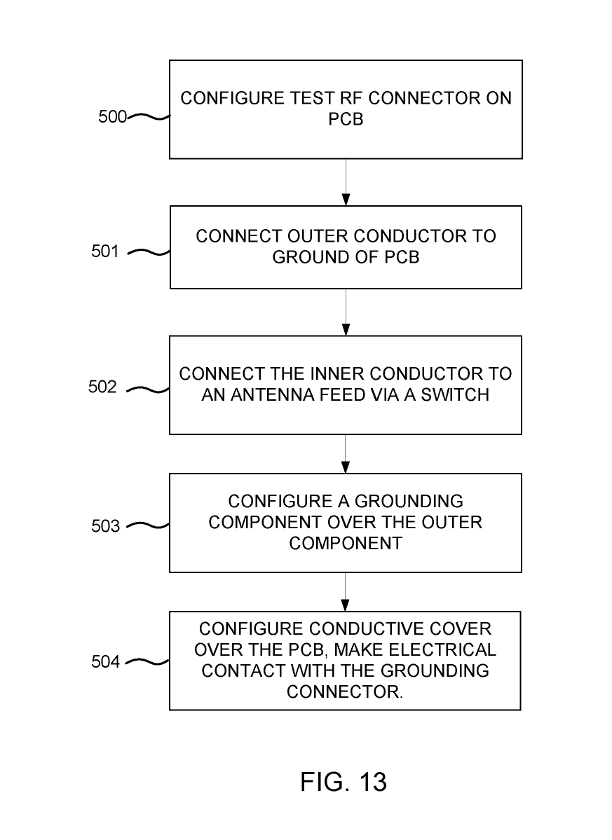

FIG. 13 illustrates, as a schematic flow chart, a method in accordance with an embodiment. Referring to FIG. 13, according to an embodiment the process may comprise operations 500, 501, 502, 503, and 504.

Operation 500 may include configuring a test RF connector 120 on a printed circuit board 110. The test RF connector 120 comprising an outer conductor 131 and an inner conductor 132 electrically isolated from each other.

Operation 501 may include electrically connecting the outer connector 131 to an electrical ground on the PCB 110.

Operation 502 may include electrically connecting the inner connector 132 to an antenna feed using a coaxial cable. A switch may be configured on the coaxial cable to allow disconnection of the antenna feed after assembly.

Operation 503 may include a configuring a grounding connector for example a spring 133, over or around the outer conductor 131. According to an embodiment, the grounding connector may be removably configured over or around the outer conductor 131.

Operation 504 may include placing a cover comprising at least one conductive portion 102, wherein the conductive portion 102 is in electrical contact with the grounding connector, for example a spring 133.

The methods and functionalities described herein may be performed by software in machine readable form on a tangible storage medium e.g. in the form of a computer program comprising computer program code means adapted to perform all the functions and the operations of any of the methods described herein when the program is run on a computer and the physical execution may be carried out by actuators configured suitably and where the computer program may be embodied on a computer readable medium. Examples of tangible storage media include computer storage devices such as disks, thumb drives, memory etc. and do not include propagated signals. The software can be suitable for execution on a parallel processor or a serial processor such that the method operations may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

The embodiments illustrated and described herein as well as embodiments not specifically described herein but within the scope of aspects of the disclosure constitute exemplary means for connecting two RF components, exemplary means of providing connector to test RF components and exemplary means for grounding a device cover or a portion thereof by electrically connecting it to a ground on a device PCB. For example, the elements illustrated in FIG. 1 to FIG. 12 constitute exemplary means for connecting two RF components, exemplary means of providing connector to test RF components and exemplary means for grounding a device cover or a portion thereof by electrically connecting it to a ground on a device PCB.

An embodiment relates to a radio frequency (RF) device comprising: a test RF connector; a device housing, the device housing comprising at least one conductive portion; and a grounding connector configured to electrically connect the at least one conductive portion to a ground of the test RF connector.

Alternatively or in addition to the above, the test RF connector comprises an inner conductor configured to carry RF signal during testing and a circum-enveloping outer housing configured to connect to an electrical ground. Alternatively or in addition to the above, the grounding connector is configured between the cylindrical outer housing of the test RF connector and a ground of the at least one conductive portion of the device housing. Alternatively or in addition to the above, the grounding connector comprises a helical conductive spring, configured around and making electrical contact with the cylindrical outer housing, having a height higher than the cylindrical outer housing; configured to make contact with the at least one conductive portion of the device housing and compress when the device housing is configured in place during device assembly. Alternatively or in addition to the above, the grounding connector comprises a helical spring configured on top of the cylindrical outer housing of the test RF connector, such that the base of the helical spring is flush with the rim of the cylindrical outer housing. Alternatively or in addition to the above, the grounding connector comprises a lamellar piece of metal bent such that it makes electrical contact between the test RF connector and the at least one conductive portion of device housing, when the device is assembled. Alternatively or in addition to the above, the grounding conductor comprises a conductive helical spring and an electrical component configured on top of the helical spring; wherein the spring is configured around or on top of the outer cylindrical housing of test RF connector and the electrical component is configured to make electric contact with the at least one conductive portion of a cover of the device, when the device is assembled. Alternatively or in addition to the above, the electrical component comprises a capacitor, an inductor, a resistor, a conductive plate, or a combination thereof. Alternatively or in addition to the above, the grounding connector comprises a capacitor, an inductor, a resistor, a conductive plate, or a combination thereof.

An embodiment relates to a test radio frequency (RF) connector, adapted to be configured on a printed circuit board PCB, comprising: an inner conductor configured to carry an RF signal; an outer conductor, circum-enveloping and electrically isolated from the inner conductor configured to be connected to an electrical ground of the PCB, wherein the inner and outer conductor are suitable to receive a complementary connector and form an RF connection; and a grounding connector configured on top of or around the outer conductor, wherein the grounding connector is configured to electrically connect at least one portion of a device to the electrical ground.

Alternatively or in addition to the above, the grounding connector comprises a helical spring configured around the outer conductor. Alternatively or in addition to the above, the grounding connector further comprises a conductive plate configured on top of the spring. Alternatively or in addition to the above, the grounding connector further comprises an electrical component configured on top of the helical spring. Alternatively or in addition to the above, the grounding connector comprises a hollow cylinder and an electrical component configured at the top of the cylinder; the hollow cylinder being configured to connect telescopically with the outer conductor of test RF connector. Alternatively or in addition to the above, the electrical component configured on top of the hollow conductor comprises a resistor, a capacitor, an inductor, or a combination thereof. Alternatively or in addition to the above, the grounding connector comprises an annular portion configured around and electrically connected to the outer conductor and at least one lamellar portion extending from the annular portions, the lamellar portion comprising a bend towards a vertical axis of the inner conductor. Alternatively or in addition to the above, the grounding connector is removable. Alternatively or in addition to the above, the grounding conductor is irremovably configured.

According to an embodiment, a method, comprising: configuring a test RF connector on a printed circuit board (PCB), wherein the test RF connector comprises an outer conductor and an inner conductor; electrically connecting the outer conductor to an electrical ground of the PCB; configuring the inner conductor to be connectable to an antenna feed; configuring a grounding connector over the outer conductor; placing a cover comprising at least one conductive portion over the PCB, wherein the at least one conductive portion of the cover is in electrical contact with the grounding connector.

Alternatively or in addition to the above, the grounding connector is removably configured over the outer component.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A radio frequency (RF) device comprising:
a test RF connector;
a device housing, the device housing comprising at least one conductive portion; and
a grounding connector configured to electrically connect the at least one conductive portion to a ground of the test RF connector.

2. The device of claim 1, wherein the test RF connector comprises an inner conductor configured to carry RF signal during testing and a circum-enveloping outer housing configured to connect to an electrical ground.

3. The device of claim 2, wherein the grounding connector is configured between the cylindrical outer housing of the test RF connector and a ground of the at least one conductive portion of the device housing.

4. The device of claim 2, wherein the grounding connector comprises a helical conductive spring, configured around and making electrical contact with the cylindrical outer housing, having a height higher than the cylindrical outer housing; configured to make contact with the at least one conductive portion of the device housing and compress when the device housing is configured in place during device assembly.

5. The device of claim 2, wherein the grounding connector comprises a helical spring configured on top of the cylindrical outer housing of the test RF connector, such that the base of the helical spring is flush with the rim of the cylindrical outer housing.

6. The device of claim 2, wherein the grounding connector comprises a lamellar piece of metal bent such that it makes electrical contact between the test RF connector and the at least one conductive portion of device housing, when the device is assembled.

7. The device of claim 2 wherein the grounding conductor comprises a conductive helical spring and an electrical component configured on top of the helical spring; wherein the spring is configured around or on top of the outer cylindrical housing of test RF connector and the electrical component is configured to make electric contact with the at least one conductive portion of a cover of the device, when the device is assembled.

8. The device of claim 7 wherein the electrical component comprises a capacitor, an inductor, a resistor, a conductive plate, or a combination thereof.

9. The device of claim 1 wherein the grounding connector comprises a capacitor, an inductor, a resistor, a conductive plate, or a combination thereof.

10. A test radio frequency (RF) connector, adapted to be configured on a printed circuit board PCB, comprising:
an inner conductor configured to carry an RF signal;
an outer conductor, circum-enveloping and electrically isolated from the inner conductor configured to be connected to an electrical ground of the PCB, wherein the inner and outer conductor are suitable to receive a complementary connector and form an RF connection; and
a grounding connector configured on top of or around the outer conductor, wherein the grounding connector is configured to electrically connect at least one portion of a device to the electrical ground.

11. The test RF connector of claim 10, wherein the grounding connector comprises a helical spring configured around the outer conductor.

12. The test RF connector of claim 11, wherein the grounding connector further comprises a conductive plate configured on top of the spring.

13. The test RF connector of claim 11, wherein the grounding connector further comprises an electrical component configured on top of the helical spring.

14. The test RF connector of claim 10, wherein the grounding connector comprises a hollow cylinder and an electrical component configured at the top of the cylinder; the hollow cylinder being configured to connect telescopically with the outer conductor of test RF connector.

15. The test RF connector of claim 14 wherein the electrical component configured on top of the hollow conductor comprises a resistor, a capacitor, an inductor, or a combination thereof.

16. The test RF connector of claim 10, wherein the grounding connector comprises an annular portion configured around and electrically connected to the outer conductor and at least one lamellar portion extending from the annular portions, the lamellar portion comprising a bend towards a vertical axis of the inner conductor.

17. The test RF connector of claim 10, wherein the grounding connector is removable.

18. The test RF connector of claim 10, wherein the grounding conductor is irremovably configured.

19. A method, comprising:
configuring a test RF connector on a printed circuit board (PCB), wherein the test RF connector comprises an outer conductor and an inner conductor;
electrically connecting the outer conductor to an electrical ground of the PCB;
configuring the inner conductor to be connectable to an antenna feed;
configuring a grounding connector over the outer conductor;
placing a cover comprising at least one conductive portion over the PCB, wherein the at least one conductive portion of the cover is in electrical contact with the grounding connector.

20. The method of claim 19 wherein the grounding connector is removably configured over the outer component.
